(19) United States
(12) Patent Application Publication
(10) Pub. No.: US 2015/0286384 A1
(43) Pub. Date: Oct. 8, 2015

(54) Method Of Establishing Multi-Sensor Measuring Machine Routines

(71) Applicant: Quality Vision International, Inc., Rochester, NY (US)

(72) Inventor: Kenneth L. Sheehan, Ontario, NY (US)

(73) Assignee: Quality Vision International, Inc., Rochester, NY (US)

(21) Appl. No.: 14/247,339

(22) Filed: Apr. 8, 2014

(51) Int. Cl. G06F 3/0484; G06F 17/50

(52) U.S. Cl. CPC G06F 3/04847; G06F 3/04842; G06F 17/50

(57) ABSTRACT

Measurement routines are established for automating multi-sensor measuring machines. Selections of feature types, sensor types, and closest points on computer models information is processed for distinguishing whether the features intended for measurement lie on a boundary or on a surface of the part to be measured. Interactions through a graphical user interface to a code-generating computer allow for the selections to be made and corresponding measurement instructions to be generated.

### TECHNICAL FIELD

The invention relates to the field of metrology, particularly controls for multi-sensor measuring machines including automated sequences of measurement and their establishment via computer models of parts intended for measurement.

### BACKGROUND OF THE INVENTION

Multi-sensor measuring machines provide opportunities for measuring a wide variety of features of parts using sensors specially adapted for measuring different types of features. For example, some sensors, such as video sensors, which typically capture contrasts within images over areas of parts, are well suited for measuring the edges or corners of parts and other sensors, such as touch probes or laser probes, which typically capture relative displacements of individual points on the parts, are well suited for measuring features on part surfaces. Manufacturing requirements for particular parts are known to specify tolerances for and among features that are best measured for comparison against such tolerances by the different sensor types, which can be related to one another within the common reference frame of a multi-sensor measuring machine.

Parts are often produced in large numbers and each such part or a sampling of such parts is measured to determine if the parts are within desired tolerances or are in need for correction or rejection. Repeatability and reliability are important to achieve between measurements to provide confidence in the measurement results. Many modern measuring machines are programmed to perform a sequence of automated measurements on individual parts and to repeat the same automated sequence of measurements over a plurality of similarly defined parts. The automated programming assures that each of a set of like parts is measured in the same way.

The automated sequences are generally established by skilled metrologists, who make informed decisions as to how particular parts are to be measured. The metrologists establish which features are to be measured and the way in which the features are to be measured. These decisions can be established by recording manipulations of the measuring machine while measuring a particular part or by interfacing with a computer model of the part rendered by the computer of the measuring machine or another computer whose recorded program can be downloaded into the measuring machine.

The parts, which can be components or any object, man-made or natural, subject to spatial measurement, are modeled by computer-aided design systems, which mathematically define the parts in three-dimensional space. Graphic programming can interpret these mathematical definitions to display visible renderings of the modeled parts. Graphical interfaces allow metrologists to interact with the rendered models, manipulating the models in space and identifying particular locations on the models.

A typical sequence for programming a multi-sensor measuring machine from the perspective of the metrologist first requires the metrologist to specify the type of feature to be measured such as whether the feature is on a surface or whether the feature is a boundary of a surface such as an edge or corner. Second, the metrologist identifies the geometric attributes of the feature, such as whether the feature is a point, line, plane, circle, cylinder, cone, or sphere. Third, the metrologist chooses the type of sensor believed to be best suited to the intended measurement. Fourth, the metrologist identifies a location on the rendered model where the feature is located. If the feature was identified as being on a surface, the identified geometric construct may be superimposed on the model rendering at the closest location that is found to contain such a geometric representation. If the feature was identified as being a feature boundary, such as an edge or corner, the identified geometric construct may be superimposed along or about the closest boundary found to contain such a geometric representation. A similar sequence is followed for each successive feature to be measured. Additional substeps can also be required such as choosing appropriate lighting conditions for a video sensor or choosing the number and tracking sequence of points for a touch or laser probe. The metrologist's selections provide the necessary information for generating a program of instructions for automating a multi-sensor measuring machine for measuring parts intended to match the referenced model. The metrologist will also typically specify constructions to be formed from the measured objects and measurements to be performed and/or reported between the measured objects and/or constructions.

Such programming by metrologists is detailed and time consuming. Thus, simplifying or consolidating the programming task is desirable.

### SUMMARY OF THE INVENTION

The invention as presented in one or more embodiments provides for establishing the measurement routines of multi-sensor measuring machines more efficiently. For example, choices can be presented to metrologists engaged in establishing measurement routines in a form that allows the metrologists to make fewer selections for satisfying the information requirements of the measurement routines.

One version of the invention as a method of establishing measurement routines for multi-sensor measuring machines includes selecting both a feature type and a sensor type. The feature type is selected from a plurality of geometric constructs through a graphical user interface in communication with a code-generating computer arranged for generating machine instructions for automating the measurement routines on the multi-sensor machines. Among the usual geometric constructs are points, lines, planes, circles, cylinders, cones, and spheres. The sensor type is selected for measuring a feature of an object matching the geometric construct through the same graphical user interface. Among the usual sensor types are video sensors, touch probes, and laser sensors.

The method proceeds by loading a computer model of the object into the code-generating computer and interacting through the graphical user interface with the computer model of the object to select a point on the computer model. A representation of the selected point on the computer model is made visible through the graphical user interface. Based on the sensor type selected, a determination is made within the code-generating computer as to whether the selected point is intended to lie on a boundary of the object or on a surface of the object. Equipped with this information, the selected feature type is graphically appended on a boundary of the computer model when the selected point is determined to be intended to lie on the boundary of object and the selected feature type is graphically appended on a surface of the computer model when the selected point is determined to be intended to lie on the surface of the object. In either case, the feature type is appended to the computer model at a location exhibiting the geometric construct of the selected feature type proximate the selected point and is visible through the graphical user interface.

The graphical feedback provided to the metrologist, including the visible indication of both the selected point and the geometric construct appended to the computer model, allows the metrologist to confirm that a desired measurement step has been defined. Additional measurement and construction steps can be defined in the same way, and when competed, the code-generating computer can complete the generation of the required code for automating a compatible multi-sensor measuring machine for carrying out the established steps.

Another version of the invention as a method of establishing measurement routines for multi-sensor measuring machines includes presenting both a plurality of feature types comprising geometric constructs and a plurality of sensor types for selection through a graphical user interface in communication with a code-generating computer arranged for generating machine instructions for automating the measurement routines on the multi-sensor machines. The sensor types include a first sensor type for capturing contrasts within images over areas of an object and a second sensor type for capturing relative displacements of individual points on a surface of the object. A computer model of the object is loaded into the code-generating computer and the method provides for selecting a point on the computer model through the graphical user interface. A representation of the selected point on the computer model is made visible through the graphical user interface. The code-generating computer determines whether the selected point is intended to lie on a boundary of the object or on a surface of the object based on the sensor type selected. Thereafter, the selected feature type is graphically appended on a boundary of the computer model in a form visible through the graphical user interface when the selected point is determined to be intended to lie on the boundary of object and graphically appended on a surface of the computer model in a form visible through the graphical user interface when the selected point is determined to be intended to lie on the surface of the object. Either way, the selected feature type is appended at a location on the computer model that exhibits the geometric construct of the selected feature type proximate the selected point.

Within the code-generating computer, the selected point can be determined to be intended to lie on a boundary of the object when the first sensor type is selected through the graphical user interface and can be determined to be intended to lie on a surface of the object when the second sensor type selected through the graphical user interface. The first sensor type preferably includes a video sensor and the second sensor type includes one or both of a touch probe and a laser sensor.

### BRIEF DESCRIPTION OF THE DRAWING FIGURES

FIG. 1 is a diagram of a metrology system associated with a multi-sensor measuring machine including in addition to the measuring machine a code-generating computer linked to both a data store and a graphical user interface.

FIG. 2 is a flow chart illustrating various steps and relationships among the steps of a method of establishing measurement routines for multi-sensor measuring machines in accordance with the invention.

FIG. 3 depicts a computer model of a part in which selected geometric constructs associated with selected points are appended to the computer model.

### DETAILED DESCRIPTION OF THE INVENTION

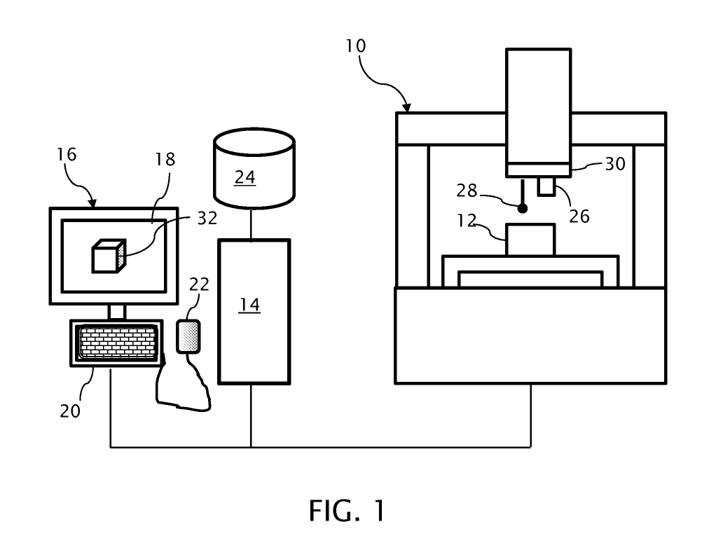

As depicted in FIG. 1, much of the apparatus associated with the invention is conventional to the art including a multi-sensor measuring machine 10 for measuring a part 12 or other type of object. The multi-sensor measuring machine 10 is automated by receiving a set of machine instructions from a code-generating computer 14 that can be a part of the control system of the multi-sensor measuring machine 10 or entirely separate. The code-generating computer 14 is in communication with both (a) a graphical user interface 16, which typically includes a display screen 18, a keyboard 20, and mouse 22, and (b) a data store 24, which can include internal or external memory to the code-generating computer 14.

The multi-sensor measuring machine 10 includes a video sensor 26 and a touch probe sensor 28. The video sensor 26, which is operated together with an illuminator 30, captures images over areas of the part 12 under predetermined lighting conditions effected by the illuminator. The images can be processed, particularly for variations in contrast, to determine the locations of part boarders, such as edges and corners. The touch probe sensor 28 is relatively moved with respect to the part 12 through a succession of contact positions via multiple axes of relative motion to collect position data on a point-by-point basis. A variety of other types of sensors can be incorporated in multi-sensor measuring machines of this general type, such as by deployable, retractable or replaceable fixturing, for gathering information about the part 12. The additional or alternative sensors can include, for example, a digital range sensor laser probe combining radiation collecting sensors with a laser spot illuminator for taking measurements through laser triangulation, a grid projector combining imaging sensors with a grid projector illuminator, a spectral probe for analyzing changes in the optical spectrum as a function of part-to-probe spacing, and a through-the lens laser probe using interferometric sensing technology through the same objective lens as a video sensor. In addition, and auto-focus adjustment can be used to use the video sensor into a point sensor.

Examples of such multi-sensor measuring machines are known from Optical Gaging Products of Rochester, N.Y. sold under the trade name SMARTSCOPE®, including SmartScope® Quests™ systems, SmartScope ZIP® systems, SmartScope® Flash™ systems, QVI® SNAP™ systems, and SmartScope® Specialist™ systems. Software for creating automated measurement routines on the multi-sensor measuring machines is sold under the trade name SmartCAD® 3D. The routines can be established with respect to computer model, i.e., a CAD (computer aided design) model and recorded for playback on the multi-axis measuring machine.

Programs operable within or in association with the code-generating computer 14 perform a number of functions including accessing information concerning the part 12 to be measured and the type of machine 10 on which part measurements are be made, displaying a computer model 32 of the part 12, presenting selections to a user (typically a metrologist), controlling user interactions with the computer model 32 of the part 12, displaying the selections referenced to a computer model 32 of the part 12, and generating machine instructions for carrying out a measurement routine on a compatible multi-sensor measuring machine 10 as defined by the user selections.

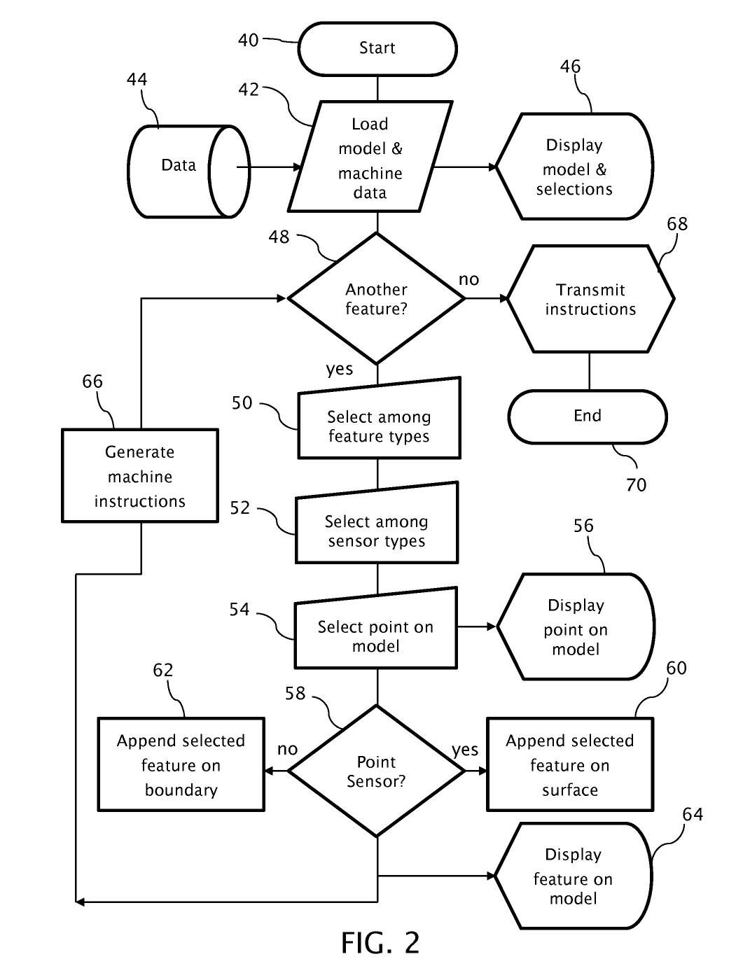

As shown in FIG. 2, an exemplary program for simplifying the establishment of such measurement routines in accordance with the invention starts with step 40 and at succeeding step 42 loads computer model data concerning the part 12 intended for measurement and machine data concerning the multi-sensor measuring machine 10 intended for measuring the part 12 into the code-generating computer 24. The data is accessed at step 44 from the data store 24, which can represent a single source or multiple sources for the information, including links to processing stations for generating CAD (computer-aided design) models of parts and to measuring machines having predefined axes of relative movement and predefined sensor and illuminator arrangements.

The accessed computer model 32 of the part 12 can be displayed on the display screen 18 of the graphical user interface 16 along with various selections for exploiting the measuring capabilities of the multi-sensor measuring machine 10. The computer model 32 and the machine selections can be displayed at step 46, together or in sequence as needed, for aiding a metrologist for defining a measurement program for automating measurement operations of the multi-sensor measuring machine 10. The various selections can be accessed in a usual graphical format such as through menus or tool bars.

A decision step 48 at a gateway to a measurement routine generating loop questions whether a measurement routine for an additional feature of the part 12 represented by the computer model 32 is to be defined. Clearly, the answer is “yes” for defining a first measuring routine for measuring a first feature of interest. Upon entering the loop, the metrologist at step 50 is presented through the graphical user interface 16 with a selection among the feature types intended for the first measurement. The feature types are presented as a choice among various geometric constructs that might be found in the computer model 32 including a point, a line, a plane, a circle, a cylinder, a cone, and a sphere. Of course, other geometric constructs can be presented to describe features associated with other mathematical definitions of solids in space.

Following the selection of a feature type, the metrologist is presented at step 52 through the graphical user interface 16 with a selection among the sensor types that are available for use on the multi-sensor measuring machine 10. As depicted in FIG. 1, the multi-sensor measuring machine 10 only includes video sensor 26 and a touch probe sensor 28 but sensors of many other types including contact and non-contacting sensors, and particularly a wide variety of optical sensors tied to a controlled form of illumination are possible.

After selecting the sensor type, the metrologist at step 54 selects a point on the computer model 32. The selection is an interactive exercise in which the metrologist orients the computer model 32 on the display screen 18 as desired and moves a cursor tool such as a pointer or crosshair via the mouse 22 or other control mechanism such a joystick, arrow keypad, or tracker camera, to a location on the computer model 34 near the feature intended for measurement. When the desired location is identified, the metrologist selects the location, such as by a mouse click or keystroke, and at step 56, the selected location is indicated on the computer model 32, such as by displaying a contrasting color dot or crosshair.

The selection steps 50 through 54 can be made in different orders to provide the information required to define a routine for measuring a particular feature of the part 12 as represented by the computer model 32. However, even with this information, an ambiguity remains as to whether the selected geometric construct is to be associated with a boundary of the part 12 as represented by the computer model 32 or with a surface of the part 12 as so represented. Instead of requiring another selection, logical processing advances to a decision step 58 that queries available information concerning the selected sensor. If the selected sensor is of a given type, for example, intended for measuring relative displacements of individual points on the parts, an assumption can be made that the geometric construct lies on a surface of the part 12 as represented by the computer model 32.

Alternatively, if the selected sensor is deemed of a type to capture optical contrasts within images over areas of parts, an assumption can be made that the geometric construct lies on a boundary of the part 12 as represented by the computer model 32. If the answer to the referenced query of decision step 58 is “yes” (i.e., the selected point is determined to be intended to lie on the surface of the part 12), the selected feature type is graphically appended at step 60 on a surface of the computer model 32 at a surface location exhibiting the geometric construct of the selected feature type proximate the selected point. If the answer to the referenced query of decision step 58 is “no” (i.e., the selected point is determined to be intended to lie on the boundary of the part 12), the selected feature type is appended at step 62 on a boundary of the computer model 32 at a boundary location exhibiting the geometric construct of the selected feature type proximate the selected point.

The computer model 32 defines at least the surfaces and their boundaries intended for measurement in a mathematical fashion. Having distinguished whether the geometric construct is to be appended to a surface or a boundary of the computer model 32, the geometric construct (itself defined in a mathematical fashion) can be compared to the computer model 32 in various positions and orientations to determine a location closest to the selected point on the computer model 32 at which a local fit is found between the geometric construct and the computer model 32. Once the fit is determined, the geometric construct is displayed at step 64 on the computer model 32 in a form that is visible through the graphical user interface 16.

Having identified, the geometric construct and its location in the computer model 32, along with the sensor intended for collecting measurement data, machine instructions are generated at step 66 for carrying out the defined measurement on the multi-sensor measuring machine 10 for part 12 and all similar parts sharing the same computer model 32. In practice, the metrologist will usually insert construction and reporting steps between the measurement steps, e.g. he may select two edge features that intersect and then construct the intersection of those two lines as a point; the location of that point may be reported or designated as a datum. Control then returns to the decision step 48, where the metrologist can choose to define another measurement routine for measuring a different feature or to transmit at step 68 the generated machine instructions for immediate or later use by the multi-sensor measuring machine 10 or a similarly arranged measuring machine. For example, the machine instructions generated by the code-generating computer 14 can be saved to the data store 24 for use as needed for operating the multi-sensor measuring machine 10 or as a starting point for generating new machine instructions. Step 70 concludes the program.

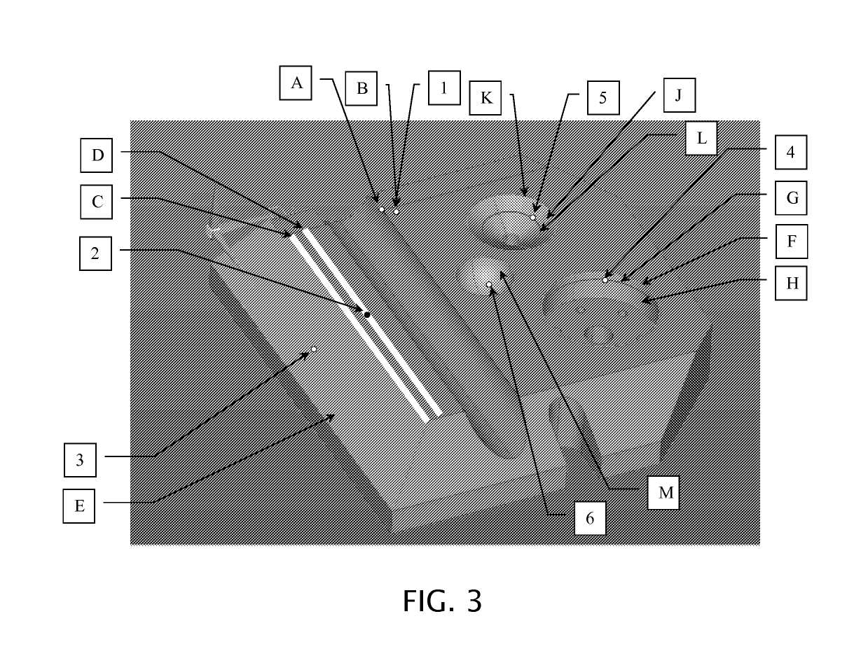

FIG. 3 depicts a number of examples in which selected geometric constructs associated with selected points 1 through 6 are appended to the computer model 32 in visible positions that can be influenced by whether the feature intended for measurement is located on the surface or on a boundary of the part 12. In a first of eight examples, the geometric construct (feature type) is a point, and the selected point displayed on the computer model 32 is designated as “1”. A point geometric construct “A” is appended to a nearest boundary corner if the applied logic concludes that the point 1 is intended to lie on the boundary of the computer model 32; and a point geometric construct “B” is appended coincident with the selected point 1 if the applied logic concludes that the point 1 is intended to lie on the surface of the computer model 32.

In the second example, the geometric construct is a line, and the selected point displayed on the computer model 32 is designated as “2”. A line geometric construct “C” is appended to a nearest boundary edge if the applied logic concludes that the point 2 is intended to lie on the boundary of the computer model 32; and a line geometric construct “D” is appended through the selected point 2 if the applied logic concludes that the point 2 is intended to lie on the surface of the computer model 32.

In the third example, the geometric construct is a plane, and the selected point displayed on the computer model 32 is designated as “3”. A plane geometric construct “E” is appended to a nearest plane on which the selected point “3” lies regardless of whether the plane is intended to involve a surface or boundary because the plane involves an area circumscribed by a boundary.

In the fourth example, the geometric construct is a circle, and the selected point displayed on the computer model 32 is designated as “4”. A circle geometric construct “F” is appended to a nearest boundary edge if the applied logic concludes that the point 4 is intended to lie on the boundary of the computer model 32; and a circle geometric construct “G” is appended through the selected point 4 if the applied logic concludes that the point 4 is intended to lie on the surface of the computer model 32.

In the fifth example, the geometric construct is also a circle, and the selected point displayed on the computer model 32 is designated as “5”. A circle geometric construct “K” is appended to a nearest boundary edge if the applied logic concludes that the point 5 is intended to lie on the boundary of the computer model 32; and a circle geometric construct “L” is appended through the selected point 5 if the applied logic concludes that the point 5 is intended to lie on the surface of the computer model 32.

In the sixth example, the geometric construct is a cylinder, and the selected point displayed on the computer model 32 is designated as “4”. A cylinder geometric construct “H” is appended to a nearest cylinder on which the selected point “4” lies regardless of whether the cylinder is intended to involve a surface or boundary because the cylinder involves an area circumscribed by a boundary.

In the seventh example, the geometric construct is a cone, and the selected point displayed on the computer model 32 is designated as “5”. A cone geometric construct “J” is appended to a nearest cone on which the selected point “5” lies regardless of whether the cone is intended to involve a surface or boundary because the cone involves an area circumscribed by a boundary.

In the eighth example, the geometric construct is a sphere, and the selected point displayed on the computer model 32 is designated as “6”. A sphere geometric construct “M” is appended to a nearest sphere on which the selected point “6” lies regardless of whether the sphere is intended to involve a surface or boundary because the sphere involves an area circumscribed by a boundary.

Various additional steps can be formed to contribute to the generation of the machine instructions, particularly steps for setting up the selected sensors. Established measurement subroutines can also be incorporated, such as subroutines for measuring particular geometric constructs with particular sensors.

1. A method of establishing measurement routines for multi-sensor measuring machines comprising:
selecting a feature type from a plurality of geometric constructs through a graphical user interface in communication with a code-generating computer arranged for generating machine instructions for automating the measurement routines on the multi-sensor machines;
selecting through the same graphical user interface a sensor type for measuring a feature of an object matching the geometric construct;
loading a computer model of the object into the code-generating computer;
interacting through the graphical user interface with a computer model of an object to select a point on the computer model and produce a representation of the selected point on the computer model that is visible through the graphical user interface;
determining within the code-generating computer whether the selected point is intended to lie on a boundary of the object or on a surface of the object based on the sensor type selected through the graphical user interface;
graphically appending the selected feature type on a boundary of the computer model in a form visible through the graphical user interface at a location exhibiting the geometric construct of the selected feature type proximate the selected point when the selected point is determined to be intended to lie on the boundary of object; and
graphically appending the selected feature type on a surface of the computer model visible through the graphical user interface at a location exhibiting the geometric construct of the selected feature type proximate the selected point when the selected point is determined to be intended to lie on the surface of the object.

2. The method of claim 1 further comprising a step of generating with the code-generating computer machine instructions for automating a compatible multi-sensor measuring machine for carrying out a measurement of the object using the selected sensor type for capturing information about the object referenced to the geometric construct appended to the computer model.

3. The method of claim 1 in which the geometric constructs from which the feature type is selected include a point, a line, a plane, and a circle.

4. The method of claim 3 in which the geometric constructs from which the feature type is selected further include a cylinder, a cone, and a sphere.

5. The method of claim 1 in which the sensor types from which the sensor is chosen include a video sensor for measuring boundaries of the object.

6. The method of claim 5 the sensor types from which the sensor is chosen include at least one of a touch probe and a laser sensor for measuring points on the surface of the object.

7. The method of claim 5 in which the boundaries measurable by the video sensor include edges and corners of the object.

8. The method of claim 1 further comprising repeating the steps of selecting the feature type, selecting the sensor type, interacting through the graphical user interface, determining within the code-generating computer, and graphically appending the selected feature type for adding measurement routines.

9. A method of establishing measurement routines for multi-sensor measuring machines comprising:
presenting a plurality of feature types comprising geometric constructs for selection through a graphical user interface in communication with a code-generating computer arranged for generating machine instructions for automating the measurement routines on the multi-sensor machines;
presenting a plurality of sensor types for selection through the same graphical user interface, wherein the sensor types include a first sensor type for capturing contrasts within images over areas of an object and a second sensor type for capturing relative displacements of individual points on a surface of the object, loading a computer model of the object into the code-generating computer;
providing for selecting a point on the computer model through the graphical user interface;
producing a representation of the selected point on the computer model that is visible through the graphical user interface;
determining within the code-generating computer whether the selected point is intended to lie on a boundary of the object or on a surface of the object based on the sensor type selected through the graphical user interface;
graphically appending the selected feature type on a boundary of the computer model in a form visible through the graphical user interface when the selected point is determined to be intended to lie on the boundary of object; and
graphically appending the selected feature type on a surface of the computer model in a form visible through the graphical user interface when the selected point is determined to be intended to lie on the surface of the object,
wherein the selected feature type is appended at a location on the computer model that exhibits the geometric construct of the selected feature type proximate the selected point.

10. The method of claim 9 in which the selected point is determined to be intended to lie on a boundary of the object when the first sensor type is selected through the graphical user interface and is determined to be intended to lie on a surface of the object when the second sensor type selected through the graphical user interface.

11. The method of claim 10 in which the first sensor type includes a video sensor.

12. The method of claim 11 in which the second sensor type includes one of a touch probe and a laser sensor.

13. The method of claim 9 further comprising a step of generating with the code-generating computer machine instructions for automating a compatible multi-sensor measuring machine for carrying out a measurement of the object using the selected sensor type for capturing information about the object referenced to the geometric construct appended to the computer model.

14. The method of claim 9 further comprising repeating the steps of presenting the plurality of feature types, presenting the plurality of sensor types, providing for selecting the point on the computer model, producing a representation of the selected point, determining within the code-generating computer, and graphically appending the selected feature type for adding measurement routines.
